(19) United States
(12) Patent Application Publication
(10) Pub. No.: US 2022/0307260 A1
(43) Pub. Date: Sep. 29, 2022

(54) System for Reversibly Dividing a Space

(71) Applicant: Adaptive XYZ, Inc., Provo, UT (US)

(72) Inventors: Benjamin Jensens, Orem, UT (US); Jonathon Marshal, Mapleton, UT (US); Hugo Garrido, Springville, UT (US)

(21) Appl. No.: 17/806,779

(22) Filed: Jun. 14, 2022

Related U.S. Application Data
(63) Continuation-in-part of application No. 16/447,956, filed on Jun. 20, 2019, now Pat. No. 11,359,372.

(51) Int. Cl. E04B 2/82; E05D 15/16

(52) U.S. Cl. CPC E04B 2/827; E04B 2/828; E05D 15/165; E05Y 2900/142

(57) ABSTRACT

A system for reversibly providing a wall, comprising: a first panel comprising first track followers on each of opposite side edges of the first panel; a first pair of tracks adapted to receive the first track followers and that are generally vertical on opposite sides of a space, each comprising: a top at a point overhead, and a lower point part-way to the floor of the space; a second panel comprising: upper second track followers on sides of the second panel near a top edge of the second panel, and lower second track followers on sides of the second panel near a bottom edge of the second panel; wherein, as the first panel is lowered, the first track followers ride in one of the first pair of tracks until at least one first track follower reaches the bottom of the one of the first pair of tracks, thus allowing the first panel, when lowered, to form a first portion of the wall; a second panel comprising: upper second track followers on each of opposite side edges of the first panel proximate to a top edge of the second panel, lower second track followers on each of opposite side edges of the first panel proximate to a bottom edge of the second panel; a second pair of tracks that are generally vertical on opposite sides of the space to be divided and generally parallel to the first set of tracks, each comprising: a top at a point overhead, a junction where a spur track separates from the second track, a spur track at a point part-way to the floor that angles over from the second pair of tracks to a point below and in vertical alignment the first pair of tracks, a bottom at a point at or above the floor, wherein the lower second track follower interacts with the toggle switch, as the second panel is lowered, to move the toggle switch from a first position to a second position, and wherein the lower second track follower interact with the toggle switch, as the second panel is raised, to move the toggle switch from the second position to the first position; wherein the toggle switch, when in the second position, diverts the upper second track follower from the second pair of tracks into the spur; wherein the bottom of the second track is in vertical alignment with the first track; wherein, as the second panel is lowered, the lower second track followers reach the bottom of the second pair of tracks and the upper second track followers reach the bottom of the spur, thus allowing the second panel, when lowered, to form a second portion of the wall; and a toggle switch at the junction of the second track having a first position such that a track follower in the second track will continue past the junction remaining in the second track and will move the toggle to a second position such that a track follower in the second track will be diverted into the spur track; wherein the first top point and second top point are located above a ceiling of the space allowing the first panel and second panel to be raised and stored in an overhead position above the ceiling of the space; wherein the first and second panel can be stored in an overhead position is disclosed.

### CROSS-REFERENCE TO RELATED APPLICATIONS

This application is a continuation-in-part of U.S. patent application Ser. No. 16/447,956 titled “Systems for Reversibly Dividing a Space” filed on 20 Jun. 2019, the disclosure of which is incorporated herein by reference in its entirety.

### TECHNICAL FIELD

The systems described herein relate generally to systems and apparatus for retractable barriers or walls on the interior or on the exterior of a building.

### BACKGROUND

Modular office and home spaces are becoming more and more common. These spaces are convertible between different uses. A major challenge for modular spaces is separation of the spaces. Systems and devices for effectively separating spaces are required.

### SUMMARY

In a first aspect, the disclosure provides a system for reversibly providing a wall, comprising: a first panel comprising first track followers on each of opposite side edges of the first panel; a first pair of tracks adapted to receive the first track followers and that are generally vertical on opposite sides of a space, each comprising: a top at a point overhead, and a lower point part-way to the floor of the space; a second panel comprising: upper second track followers on sides of the second panel near a top edge of the second panel, and lower second track followers on sides of the second panel near a bottom edge of the second panel; wherein, as the first panel is lowered, the first track followers ride in one of the first pair of tracks until at least one first track follower reaches the bottom of the one of the first pair of tracks, thus allowing the first panel, when lowered, to form a first portion of the wall; a second panel comprising: upper second track followers on each of opposite side edges of the first panel proximate to a top edge of the second panel, lower second track followers on each of opposite side edges of the first panel proximate to a bottom edge of the second panel; a second pair of tracks that are generally vertical on opposite sides of the space to be divided and generally parallel to the first set of tracks, each comprising: a top at a point overhead, a junction where a spur track separates from the second track, a spur track at a point part-way to the floor that angles over from the second pair of tracks to a point below and in vertical alignment the first pair of tracks, a bottom at a point at or above the floor, wherein the lower second track follower interacts with the toggle switch, as the second panel is lowered, to move the toggle switch from a first position to a second position, and wherein the lower second track follower interact with the toggle switch, as the second panel is raised, to move the toggle switch from the second position to the first position; wherein the toggle switch, when in the second position, diverts the upper second track follower from the second pair of tracks into the spur; wherein the bottom of the second track is in vertical alignment with the first track; wherein, as the second panel is lowered, the lower second track followers reach the bottom of the second pair of tracks and the upper second track followers reach the bottom of the spur, thus allowing the second panel, when lowered, to form a second portion of the wall; and a toggle switch at the junction of the second track having a first position such that a track follower in the second track will continue past the junction remaining in the second track and will move the toggle to a second position such that a track follower in the second track will be diverted into the spur track; wherein the first top point and second top point are located above a ceiling of the space allowing the first panel and second panel to be raised and stored in an overhead position above the ceiling of the space; wherein the first and second panel can be stored in an overhead position.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1A is a cross-sectional, side elevation view of a first exemplary embodiment of a system to divide a space according to the present disclosure in a retracted position according to the present disclosure.

FIG. 1B is a cross-sectional, side elevation view of the embodiment of FIG. 1A in a partially deployed position.

FIG. 1C is a cross-sectional, side elevation view of the embodiment of FIG. 1A in a fully deployed position.

FIG. 2 is a front elevation view of a system to divide a space composed of three panels according to the present disclosure.

FIG. 3 is a cross-sectional, side elevation view of a system to divide a space composed of three panels according to the present disclosure.

FIG. 4 is a front elevation view of a system to divide a space with a door in the divider according to the present disclosure.

FIG. 5A is a cross-sectional, side elevation view of a system to divide a space in retracted position according to the present disclosure.

FIG. 5B is a cross-sectional, side elevation view of the system of FIG. 5A in a fully deployed position.

FIG. 6 is a cross-sectional side elevation view of a system to divide a space in a retracted state according to the present disclosure.

FIG. 7A is an isometric top, front view of the embodiment of FIGS. 1A-C.

FIG. 7B is an isometric top, front view of the embodiment of FIGS. 1A-C.

FIG. 7C is an isometric top, front view of the embodiment of FIGS. 1A-C.

FIG. 8A is a side view of a second exemplary embodiment of tracks and toggle switch for a system to divide a space with the toggle switch in a first position according to the present disclosure.

FIG. 8B is another side view of the embodiment of FIG. 8A with the toggle switch in a second position.

FIG. 8C is an isometric view of the embodiment of FIG. 8A showing the bottom portion of the system tracks.

FIG. 9A is an isometric view of a second exemplary embodiment of a system to divide a space in a with a top panel deployed and a bottom panel lowered to about the same height as the first panel according to the present disclosure.

FIG. 9B is an isometric view of the system of FIG. 9A with the bottom panel lowered almost to level with the top portion of the system.

FIG. 9C is an isometric view of the system of FIG. 9A with the bottom panel of the divider nearly fully lowered and deployed.

FIG. 9D is an isometric view of the embodiment of FIG. 9A with the bottom panel fully deployed.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “panel” is meant to refer to a cuboid of homogenous or non-homogenous material used as at least a partial divider of a space.

As used herein, “track” is meant to refer to is a strip of material formed so as to allow movement along a given path in a consistent manner.

As used herein, “track follower” is meant to refer to a small piece of material that is attached to a panel and rides in the track. A track follower keeps the panel material in line with the track and forces the panel to follow the path set by the track as the track follower moves along the track.

As used herein, “divider” is meant to refer to the plurality of panels used to the divide the space.

As used herein, “overhead position” is meant to refer to any space above the space to be divided. Preferably, this space will be above the ceiling, but is not restricted to this.

As used herein, “winch,” “hoist,” “lift,” “winching device,” “hoisting device,” and “lifting device” are meant to refer to an apparatus that can be actuated to selectively raise and lower an object. These terms are generally interchangeable except for where specifically noted herein.

As used herein, “spool” is meant to refer to a generally cylindrical member that rotates to wind a line thereon.

As used herein, “line” is meant to refer to a cable, cord, wire, or other suitable interchangeable generally elongated, flexible, member that winds onto the spool. A “line” may refer to any device or material that is long, cylindrical, thin, flexible, and having a high tensile strength. Preferably, this will be a braided wire, but ropes, cords, string, twine, cable, strand, chains, and combinations thereof may be used as well.

As used herein, “sound dampeners” is meant to refer to a passive material or an active device used to diminish the sound transfer through the divider.

As used herein, “gasket” is meant to refer to any material used to make a seal between two abutting surfaces. Gaskets may also be sound dampeners.

As used herein, “locking mechanism” is meant to refer to any mechanism designed to reversibly hold a plurality of objects together to prevent the dislocation of their current positions.

### Exemplary Embodiments

The disclosed invention consists of a divider being made up of independent panels, where each panel is mounted on independent, parallel tracks. The top-most panel is on a track that is generally straight. The second, and any following panels, are mounted on adjacent, parallel tracks that are approximately shaped like the letters “J” or “L” or angled like a hockey stick. The top panel moves down in a generally straight manner. The second panel moves down parallel to the first panel and then follows the track it is mounted on under the first panel to align with the first panel in a single plane. If there are other panels, the panel will move down and then below the panel that would be immediately above. The deployed panels form a divider in a room or space. In some embodiments, the second panel is lowered first.

The invention allows for a modular use of space. One advantage of this technology is removing the storage of the non-deployed wall or panels from the floor and side of the room into an overhead storage space.

In an office environment, a conference room could be divided into temporary offices for visiting executives or an interview room with an adjacent observation room. The system could be installed in a large, open, office space where smaller offices, half-walled cubicles, conference rooms, interview rooms, and break rooms could be added and removed as needed. In a law-enforcement office with limited space, a temporary interrogation room with attached observation room could be formed from a room that is normally used as a briefing or conference room by deploying a set of panels where an upper panel is made from a one-way mirror material. In case of modular living and workspace, the panels could be kept in the ceiling during the workday and lowered to enclose individual rooms for occupancy at night in conjunction with other modular means of changing the furniture in the room automatically. The system could also be installed as a window or door on an exterior of a building or as a way to open or close a porch area.

Another commercial application would be in hotels, hostels, or other lodgings. With this technology, rooms could be made larger and smaller as desired by the guest.

In a domestic environment, this could be used to create a temporary office, room, closet, or bedroom that the home only needs sporadically. This could be used in a micro-home to create smaller, multi-use spaces out of a main living space.

In various exemplary embodiments, the panels may comprise opaque or transparent materials. For example, the panels may function as an interior or exterior window. In various exemplary embodiments where one or more of the panels includes a window, the window may comprise, by way of example, single pane glass, double pane glass, or triple pane glass. The windows may have a vacuum between panes for insulation and sound dampening. Portions of the panels, with or without windows, may also be insulated against heat transfer and to prevent sound transmission.

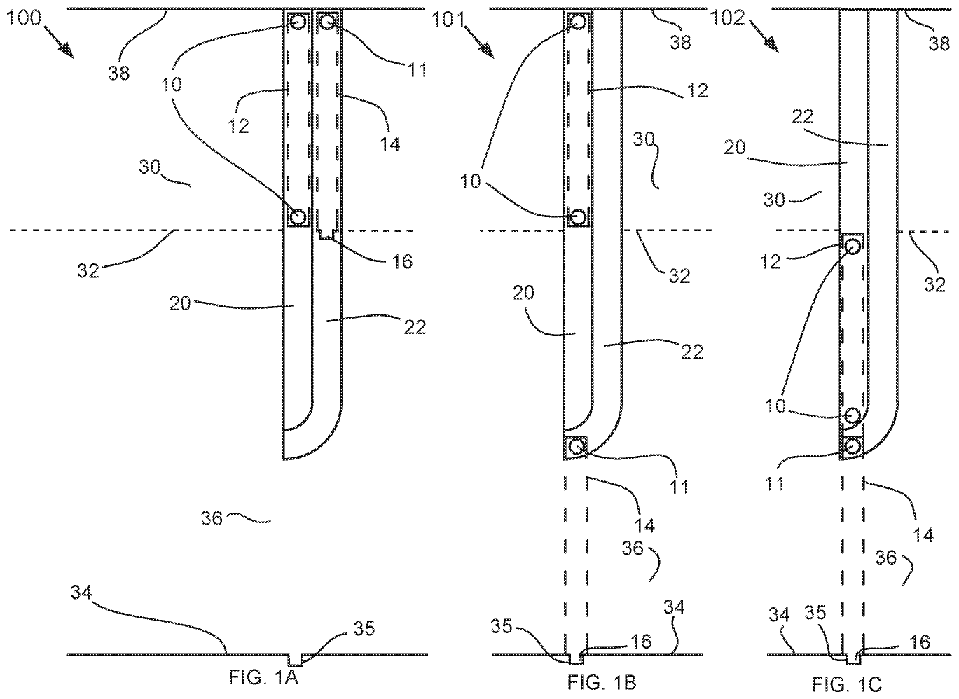

Now referring to the Figures, FIG. 1A is a cross-sectional side elevation view of a system to divide a space in the non-deployed position at 100, that may be used in one embodiment of the present invention. FIG. 1B is a cross-sectional side elevation view of the same system from FIG. 1A in a partially deployed position at 101. FIG. 1C is a cross-sectional side elevation view of the same system from FIG. 1A in a fully deployed position at 102.

At 100, first and second track followers 10 are attached to a top and a bottom portion of a first panel 12, respectively. A third track follower 11 is attached to panel 14. At 100, the first panel 12 and the second panel 14 are in a non-deployed state, stored in an overhead space 30 above a ceiling 32 and below upper limit 38. Tracks and track followers have corresponding, mirrored parts on the opposite side of panel 12 and panel 14 that are not visible. The first and second track followers 10 are mounted in a first track 20 and the third track follower 11 is mounted in a second track 22. The first panel 12 and the second panel 14 are capable of dividing space 36 above the floor 34. A gap 35 in the floor 34 corresponds to a tab 16 on the bottom of panel 14. This embodiment might be used in an office space to create small offices as needed.

At 101, the second panel 14 is lowered from its position at 100, the third track follower 11 following the path set by the second track 22 until the second panel 14 reaches the floor 34, where the tab 16 mates with the gap 35, securing panel 14 and preventing panel 14 from swinging on track follower 11 and its corresponding track follower on the opposite side of panel 14. Here, panel 14 is shown as a half-wall divider, as panel 12 is in the ceiling. This is accomplished by lowering only panel 14. This might be used to create half-walled cubicles in an office environment.

At 102, the first panel 12 is lowered from its position at 101 to form a fully deployed divider. This divider has divided the space 36 from floor 34 to ceiling 32. In an alternate embodiment, the first panel 12 can be lowered first with the second panel 14 lowered second, swinging into place. Either option allows the bottom edge of panel 12 and the top edge of panel 14 to touch while being fully deployed, preventing a gap in the wall. In other variations the lower edge of panel 12 and the upper edge of panel 14 have complimentary angled surfaces so that even if panel 12 is deployed first, it will not block panel 14 from fully deploying.

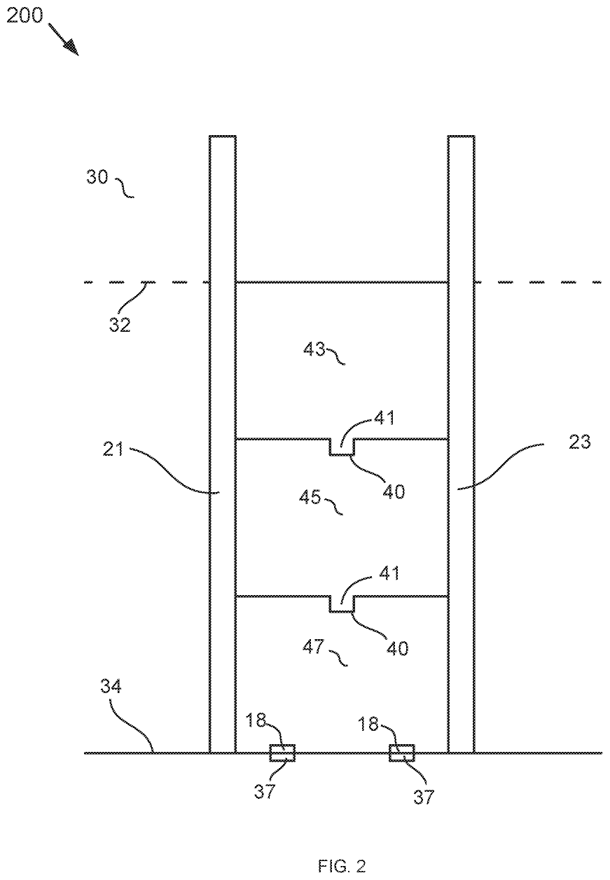

FIG. 2 is a front elevation view of a system in the fully deployed position at 200, that may be used in one embodiment of the present invention. An opaque composite panel 43 is atop a panel 45 that is made to be a one-way mirror, with another opaque panel 47 below panel 15. The panels are in a fully deployed state, dividing a space from floor 34 to ceiling 32, and leaving overhead space 30 empty. Panel 43, panel 45, and panel 47 are mounted on track set 21 and track set 23. Within track set 21 and track set 23 are three tracks, where panel 13, panel 15, and panel 17 are mounted on respective parallel tracks. Track set 21 and track set 23 are mounted on opposite walls of a space. Panel 47 contains magnets 18 in the bottom edge that align and stick to magnets 37, which are mounted in floor 34. Magnets 18 and magnets 37 act as a locking mechanism for panel 17 and floor 34. Panel 43 and panel 45 have tabs 41 that correspond and mate with slots 40 on panel 45 and panel 47, respectively. The tabs 41 and slots 40 form a locking mechanism. In some iterations, the tabs 41 having a mechanical deadbolt or pins that slide into the side of slots 40 and are only accessible one side of the divider. The size of the tabs is exaggerated for clarity in drawing. The one-way mirror panel 45, paired with the locking mechanism between tabs 41 and slots 40 and the magnets 18 and magnets 37, allow for the space divided to form secure testing or interrogation room on the mirror side with an observation room on the opposite side of the one-way mirror.

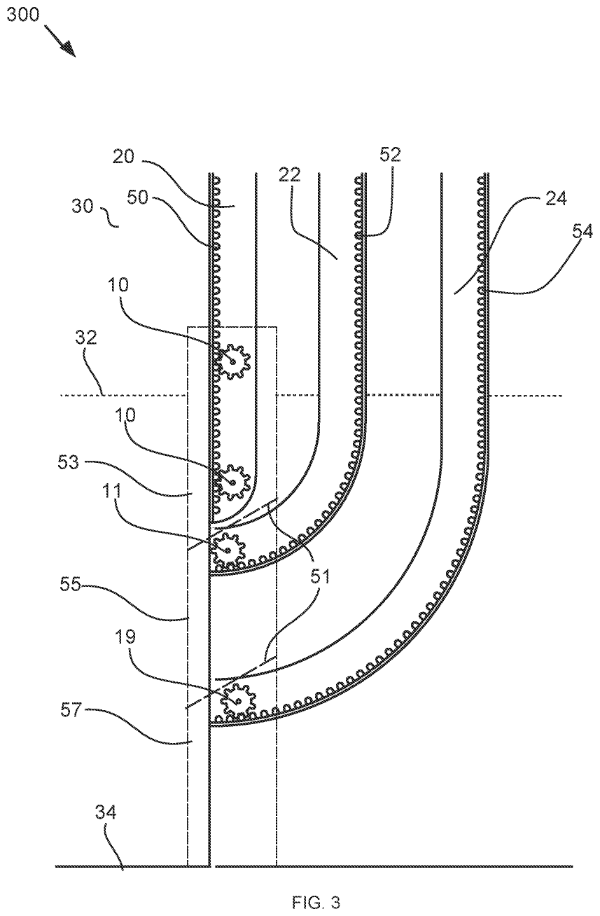

FIG. 3 is a side elevation view of a system to divide a space in a fully deployed position at 300, that may be used in one embodiment of the present invention. At 300, track 20, track 22, and track 24 are shown spaced out to allow for thick panel 53, thick panel 55, and thick panel 57, outlined in dashed lines. Track 20, track 22, and track 24 have, respectively, toothed edge 50, toothed edge 52, and toothed edge 54. Edges 51 have gaskets to create a seal between panel 53, panel 55, and panel 57. First and second pinion gear track followers 10 are attached to a top and a bottom portion of a first panel 53. Pinion gear track followers 10 are mounted on track 20, such that pinion gear track followers 10 can climb up and down toothed edge 50. A third pinion gear track follower 11 is attached to panel 55. Pinion gear track follower 11 is mounted on track 22, such that pinion gear track followers 11 can climb up and down toothed edge 52. A fourth pinion gear track follower 19 is attached to panel 57. Pinion gear track follower 19 is mounted on track 22, such that pinion gear track follower 19 can climb up and down toothed edge 54. Pinion gear track followers have built-in electric motors to provide locomotion. Panel 53, panel 55, and panel 57 contain rechargeable batteries that power the electric motors in, respectively, pinion gear track followers 10, pinion gear track follower 11, and pinion gear track follower 19. The shape of the edges 51 necessitates that the divider is deployed with panel 55 before panel 57. Storage of the panels into overhead space occurs in reverse order, with panel 57 first and panel 55 second. Panel 53 can be placed before, simultaneously, or after panel 55 and panel 57. Panel 53 does not completely leave the overhead space 30, allowing it to create a better seal between panel 53 and ceiling 32. The thickness of panel 57 in contact with the floor 34 combined with the single-track follower on the side keeps the panel stable.

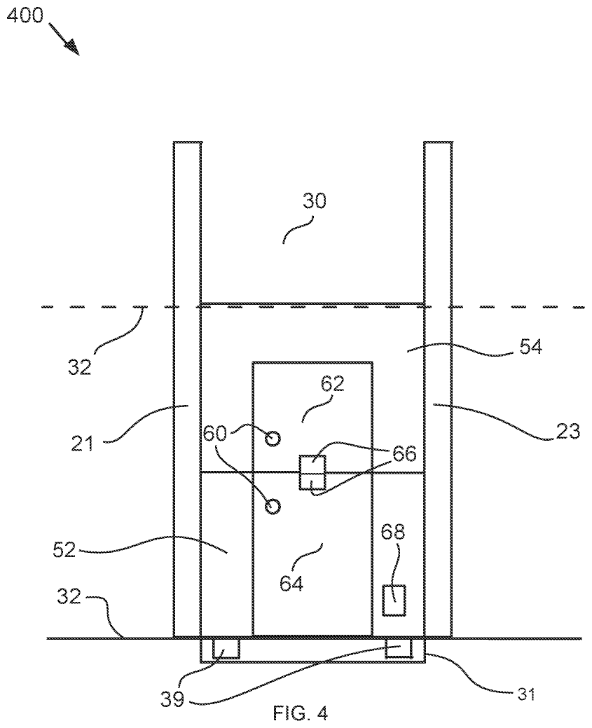

FIG. 4 is a front elevation view of a system to divide a space with a door in the divider at 400. Top panel 54 and bottom panel 52 are in a deployed position, becoming a divider with a door. Top panel 54 and bottom panel 52 are mounted on track set 21 and track set 23. Within track set 21 and track set 23 are two tracks each, where panel 52 and panel 54 are mounted on respective parallel tracks of a similar type as those shown in FIG. 1. Upper half-door 62 and lower half-door 64 have latching mechanisms 60 used to keep the upper half-door 62 and lower half-door 64 closed. Both upper half-door 62 and lower half-door 64 can be opened separately or together. If desired, locking mechanism 66 can be used to lock both upper half-door 62 and lower half-door 64 together to assist in opening and closing the combined half-doors. Pet door 68 is a cut-out in panel 52 to allow small animals, drones, and similar through panel 53. An insert may be placed in pet door 68 to ensure privacy. Panel 52 is reinforced with a ferric metal. Magnets 39 mounted in floor 32 stick to the metal reinforcement in panel 52, acting as a locking mechanism, preventing panel 52 from being lifted by mistake. When fully deployed, panel 52 slides into slot 31 in floor 32 to allow reinforcement all the way around the base of the door without creating a trip hazard while passing through the door. While fully deployed, the top of panel 54 remains above the plane of the ceiling 32 into the overhead space 30 to ensure there are no gaps at the top of the wall.

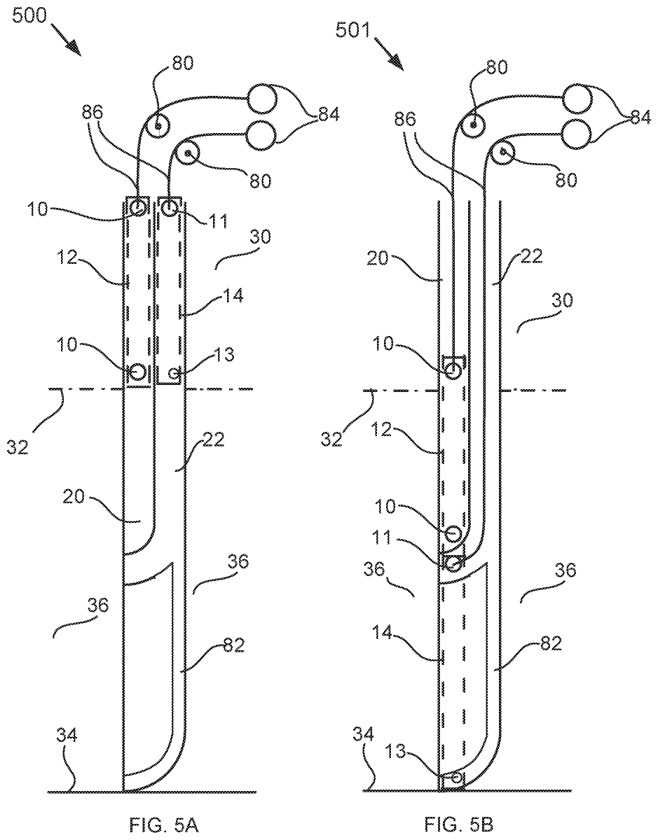

FIG. 5A is a cross-sectional, side, elevation view of a system to divide a space in the non-deployed position at 500, that may be used in one embodiment of the present invention. FIG. 5B is a cross-sectional, side, elevation view of the same system from FIG. 5A in a fully deployed position at 501.

At 500, first and second track followers 10 are attached to a top and a bottom portion of a first panel 12, respectively. A third track follower 11 is attached adjacent to the top of panel 14. A smaller track follower 13 is attached adjacent to the bottom and left portion of panel 14. The first panel 12 and the second panel 14 are in a non-deployed state and are being stored in an overhead space 30 above a ceiling 32 and below upper limit 38. Tracks and track followers have corresponding, mirrored parts on the opposite side of panel 12 and panel 14 that are not visible. The first and second track followers 10 are mounted in a first track 20 and the third track follower 11 and fourth track follower 13 are mounted in a second track 22. When panel 14 descends, track follower 13 will follow into sub-track 82. The first panel 12 and the second panel 14 are capable of dividing space 36 above the floor 34. Panel 12 and panel 14 are raised and lowered by means of winches 84 and braided cables 86. Braided cables are attached to the upper track follower 10 on panel 12 and track follower 11 on panel 14. Braided cables 86 move along pulleys 80 to translate the direction of the pull of the winches 84 from horizontal to vertical.

At 501, panel 12 and panel 14 are lowered from their position at 500 to form a fully deployed divider. This divider has divided the space 36 from floor 34 to ceiling 32. A method of reaching the fully deployed state is to start lowering panel 14 down, before starting panel 12, early enough that it will be in place before panel 12 reaches a fully lowered position and blocking panel 14 from reaching a fully lowered state. This allows the bottom edge of panel 12 and the top edge of panel 14 to touch while being fully deployed, preventing a gap in the divider. Track follower 13 travels along sub-track 82 to maintain the vertical orientation of panel 14 while panel 14 is being deployed, while deployed, and while panel 14 is retracting. Winches 84 pull and release braided cables 86 to, respectively, raise and lower panel 12 and panel 14 into and out of position. Having separate winches 84 for panel 12 and panel 14 allows for independent movement of said panels. Independent movement of panel 12 and panel 14 allows for panel 14 to be lowered separately to form a half-wall divider.

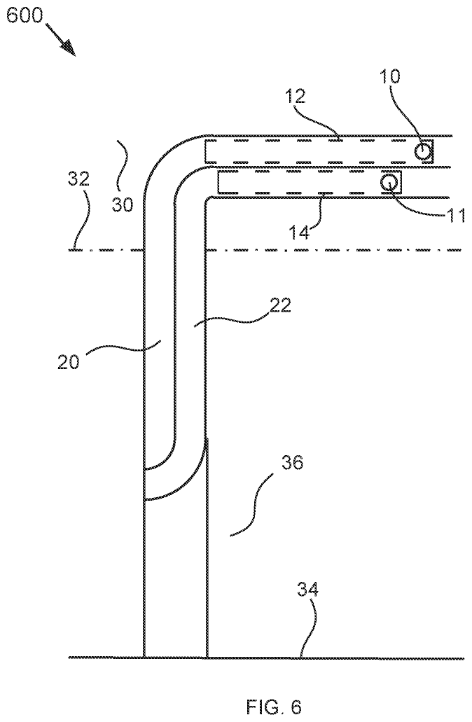

FIG. 6 is a cross-sectional side elevation view of a system to divide a space in a non-deployed state at 600, that may be used in one embodiment of the present invention. Panel 12 and panel 14 are stored horizontally in the overhead space 30. This is accomplished by shelves built into track 20 and track 22. In the overhead space 30, the horizontal section of track 20 and track 22 extend into the page and link to the mirrored tracks on the other side of panel 12 and panel 14, forming shelves. Panel 12 must be stored first, allowing the angling of panel 14 as panel 14 move into a shelf.

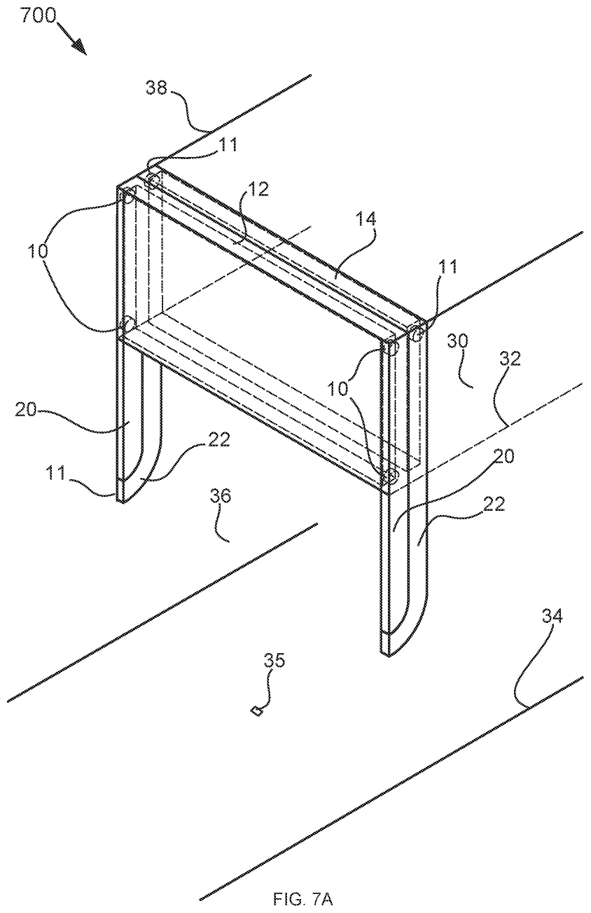

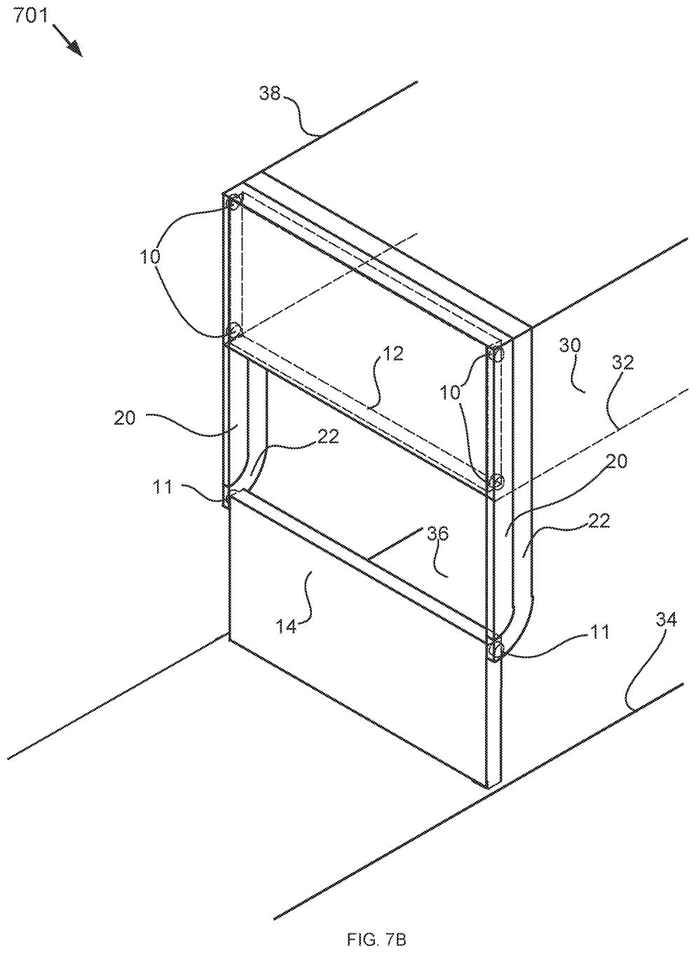

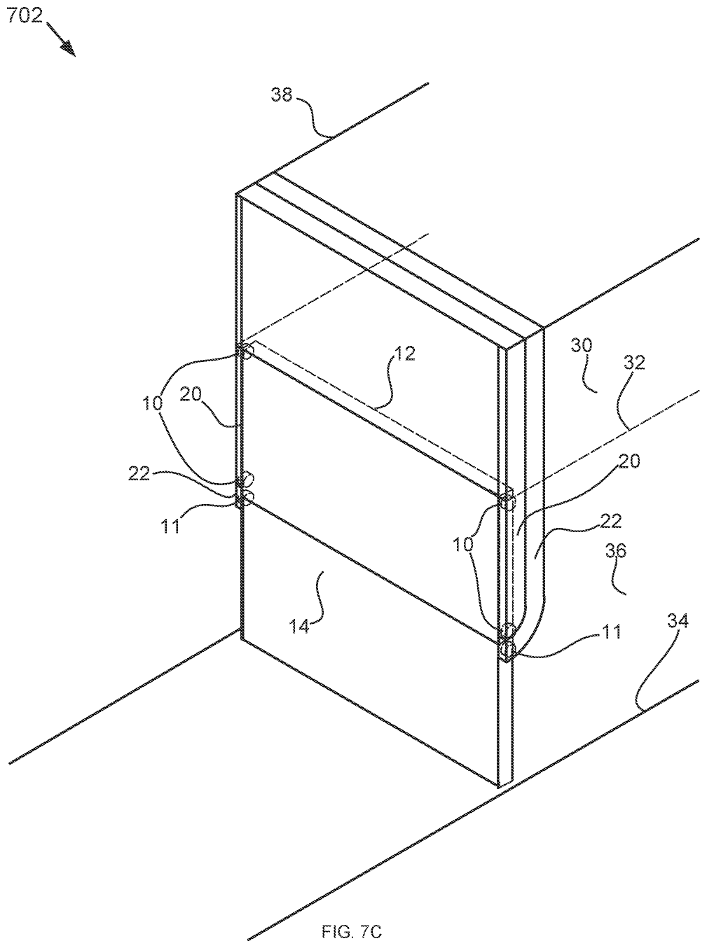

FIGS. 7A-C are isometric top, front side elevation views of the same system from FIGS. 1A-C, respectively.

At 700, an isometric view of the system in FIG. 1B, is shown. Track followers 10 are attached to panel 12 and mounted on tracks 20. Track followers 11 are attached to panel 14 and mounted on track 11. Panel 12 and panel 14 are in a non-deployed state and are being stored in an overhead space 30 above a ceiling 32 and below upper limit 38. When the second panel 14 is lowered, the track followers 11 follow the path set by tracks 22 until the bottom edge of panel 14 reaches the floor 34. A tab on the bottom of panel 14, which is not visible in the drawing, mates with a gap 35 in the floor, securing panel 14 and preventing panel 14 from swinging on track followers 11. As shown, tracks 20 and tracks 22 are ceiling mounted, allowing panel 12 and panel 14 are deployable in the middle of a space, without permanent walls adjacent. This might be used to create half-walled cubicles or full walled offices in an open office environment by mounting multiple systems around a rectangle.

At 701, panel 14 is lowered from its position at 700, track followers 11 following the path set by the tracks 22. When panel 14 reaches the floor 34, where the unseen tab mates with gap 35, visible in FIG. 7A. Here, panel 14 is shown as a half-wall divider, as panel 12 remains in the ceiling.

At 702, panel 12 is lowered from its position at 701, track followers 10 following the path set by the tracks 20, until the bottom edge of panel 12 touches the top edge of panel 14. Panel 12 and panel 14 form a divider from floor 34 to ceiling 32, leaving overhead space 30 empty. The fully deployed divider could be the wall of a temporary office in an open office.

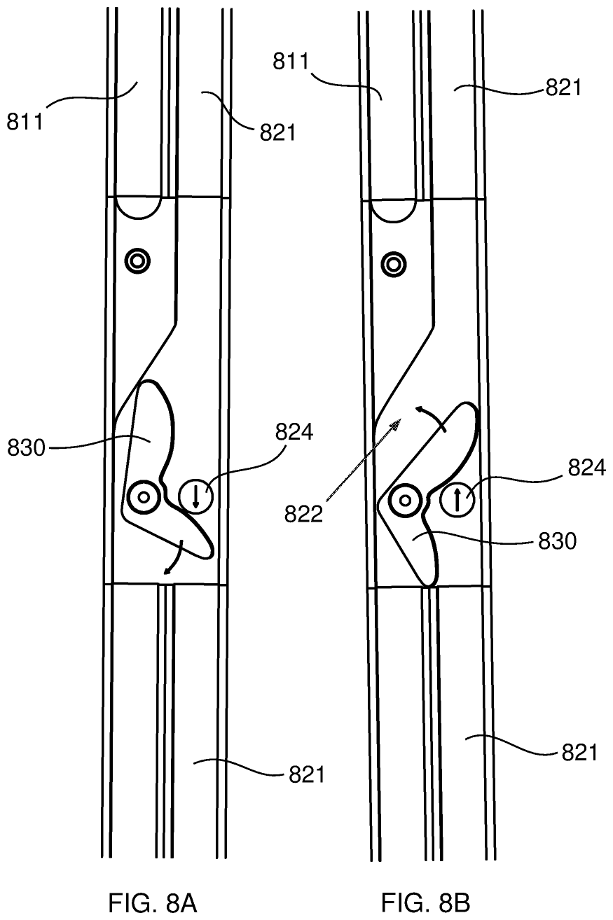

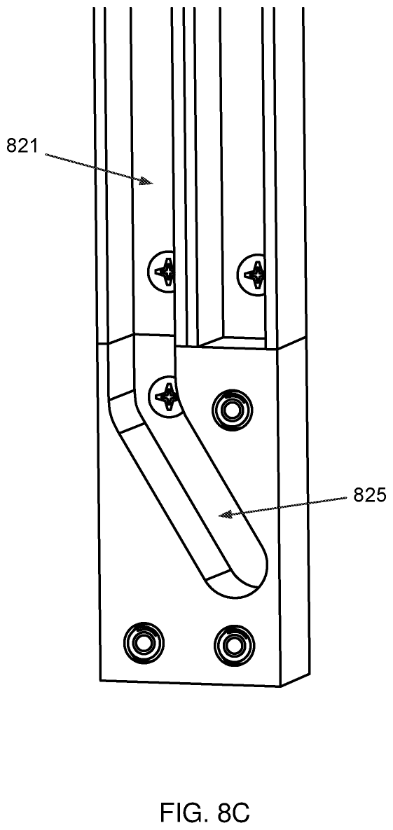

Now referring to FIGS. 8A-C, the tracks for another embodiment of a system for dividing a space is shown. As with prior embodiments, the tracks on opposite sides of the space to be divided are mirror images of one another. In various exemplary embodiments, the tracks include a first pair of tracks 811 for use by a first panel 810 that is the top or uppermost panel 810 when the system is deployed. In preferred embodiments, the first pair of tracks 811 are vertical and straight.

In various exemplary embodiments, the second pair of tracks 821 include an upper portion parallel to the first pair of tracks 811. At a point slightly below the bottom of the first pair of tracks, a toggle switch 830 is pivotally attached in the second pair of tracks 821. The toggle switch 830 comprises a pivot and two cam arms. In FIG. 8A, the toggle switch 830 is shown in a first position. In the first position, the system is prepared for deployment. With the toggle switch 830 in the first position, a lower track follower 824 descending along track 821 is allowed to continue straight down track 821. As the track follower contacts the toggle switch 830, it pivots the toggle switch 830 to the second position (as illustrated by the arrows in FIG. 8A). In FIG. 8B, the toggle is shown in a second position. In the second position, a track follower descending down the second track 821 is diverted out of second track 821 into spur 822, formed in part by the toggle switch 830. When the second panel 820 is raised, the lower track follower 824 interacts with the toggle switch 830 again returning it to the first position (as shown with arrows in FIG. 8B).

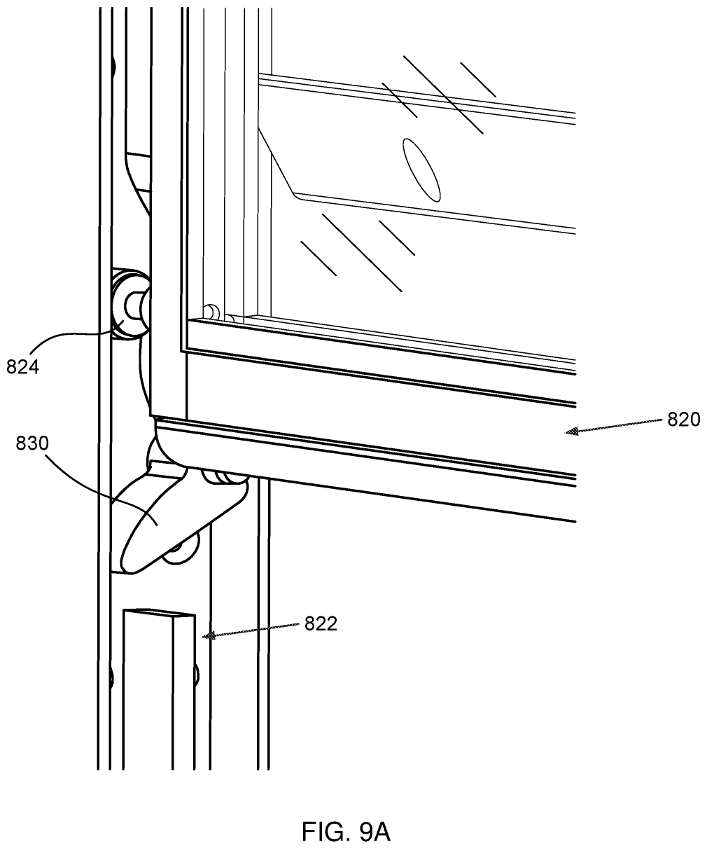

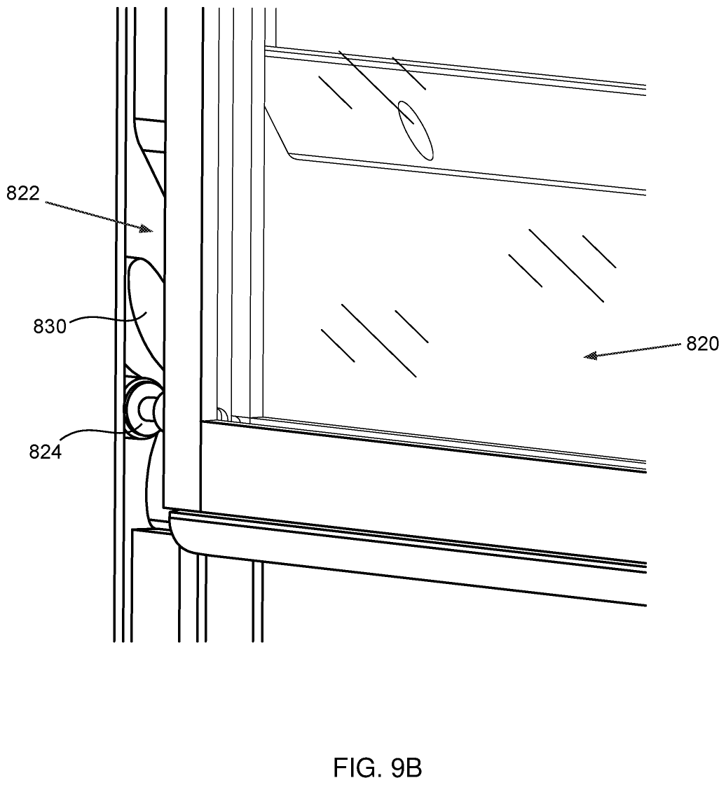

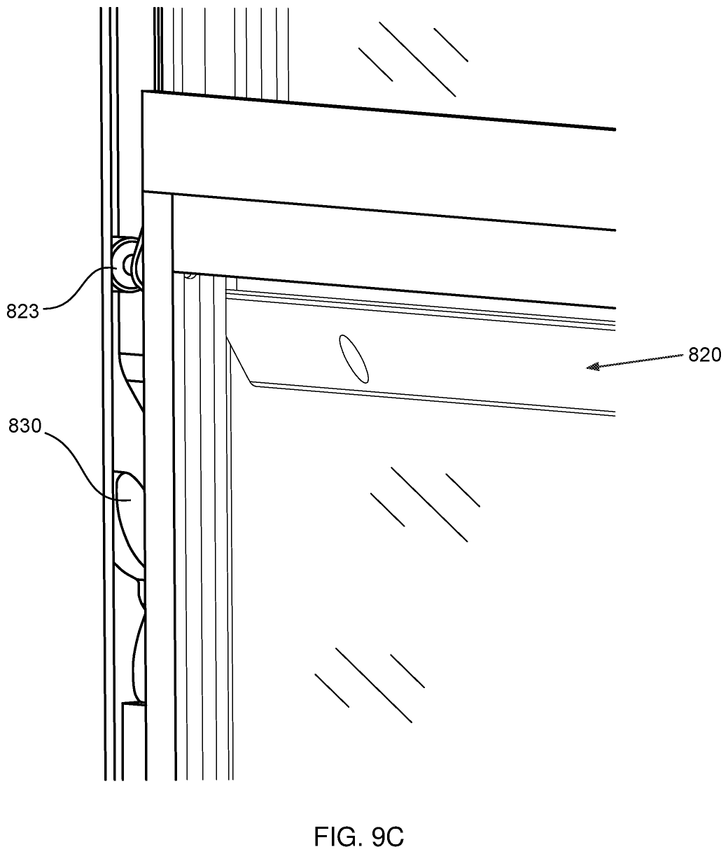

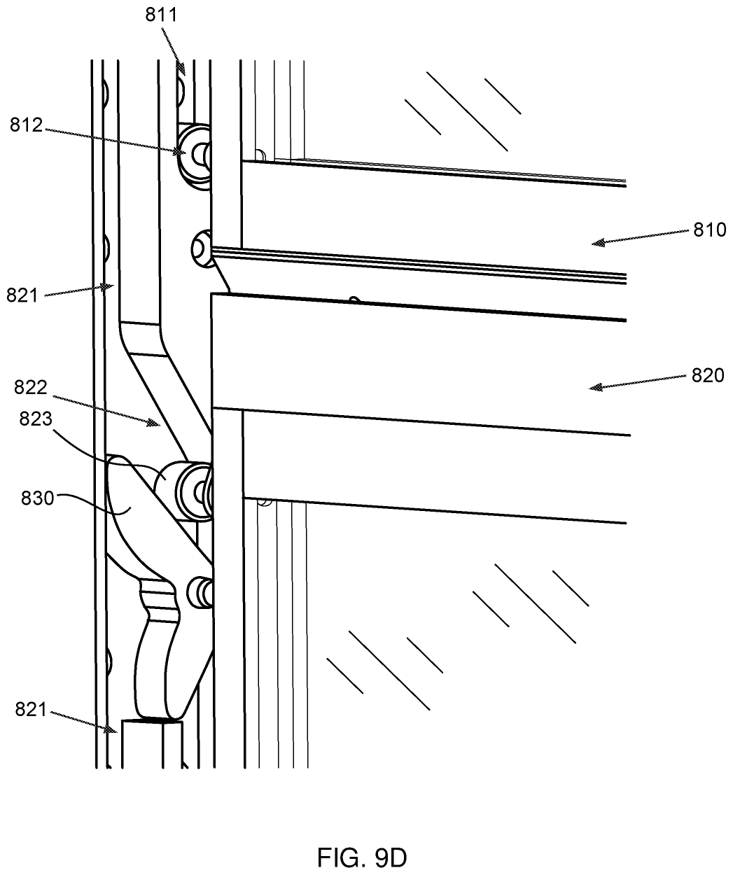

Now referring to FIG. 8C, the bottom of the second track 821 is shown. lower second track followers 824 on the bottom of the second panel continue to travel straight down and then angle over near the bottom of the tracks (see FIG. 9). The upper track followers at the top of the second panel reach the toggle 830 and are diverted to the spur track 822 to their final position. the bottom of a second track 821 is shown. Like the spur track 822, the second track bottom 825 angles over to a point below the first track 811 such that the second panel 820 is aligned with the first panel 810 when fully deployed. In various exemplary embodiments, the track bottom 825 may take a variety of shapes including the “J” or “L” shapes discussed above or the hockey stick shape of FIG. 9.

Now referring to FIGS. 9A-D, an embodiment of a system for dividing a space using the tracks of FIGS. 8A-C is shown. In the illustrated embodiment, the system comprises two panels. In other embodiments, the system may include 3 or more panels.

The first panel 810 simply moves straight up and down in first tracks 811 with first track followers 812. The second panel 820 uses the second tracks 821, as shown in FIGS. 8A-C. As the second panel 820 is lowered, as illustrated in FIG. 9A, the upper track second follower 823 follows second track 821 to the toggle switch 830 and continues straight down second track 822 past the toggle switch. In doing so, as shown in FIG. 9B, the lower second track follower contacts a cam arm of the toggle switch 830 and rotates it to the second position.

As the second panel 820 continues to lower, as shown in FIG. 9C, the upper track follower 823 follows the second track 821 down to toggle 830. As shown in FIG. 9D, the upper track follower 823 reaches the toggle 830, which is in the second position, and is diverted out of second track 821 into spur 822 formed in part by a cam arm of the toggle switch 830.

When the panels are retracted, the process is reversed. The lower second track followers interact with the toggle switch as the panel rises returning the toggle switch to the first position (see FIG. 8B).

As discussed above, other embodiments may include additional panels. In such embodiments, a third or subsequent pair of tracks runs parallel to the second pair of tracks with their own toggle and spur that would put it in alignment with the other panels in the same manner as the second pair of tracks and second panel.

In preferred embodiments, the panels are connected or connectable to one or more hoisting devices comprising a motor, spool, and line. Useful hosting devices are disclosed in U.S. patent app. Nos. 63/284,344 titled “Winch with Multiple Spools On Single Driveshaft” filed 6 Dec. 2021, 63/284,356 titled “Winch with Helical Groove and Line Guide” filed 6 Dec. 2021, 63/284,370 titled “Winch with Spool and Remote Tensioning Wheel” filed 6 Dec. 2021, 63/284,390 titled “Hoisting Device with Multiple Line Types On Driveshaft” filed 6 Dec. 2021, and 63/284,403 titled “Winch with Line Guide Driven By Wound Line” filed 6 Dec. 2021, each of which are incorporated herein by reference in their entireties.

The invention has been described with reference to various specific and preferred embodiments and techniques. Nevertheless, it is understood that many variations and modifications may be made while remaining within the spirit and scope of the invention.

All patents, published patent applications, and other publications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for reversibly providing a wall, comprising:
a first panel comprising first track followers on each of opposite side edges of the first panel;
a first pair of tracks adapted to receive the first track followers and that are generally vertical on opposite sides of a space, each comprising:
a top at a point overhead, and
a lower point part-way to the floor of the space;
a second panel comprising:
upper second track followers on sides of the second panel near a top edge of the second panel, and
lower second track followers on sides of the second panel near a bottom edge of the second panel;
wherein, as the first panel is lowered, the first track followers ride in one of the first pair of tracks until at least one first track follower reaches the bottom of the one of the first pair of tracks, thus allowing the first panel, when lowered, to form a first portion of the wall;
a second panel comprising:
upper second track followers on each of opposite side edges of the first panel proximate to a top edge of the second panel,
lower second track followers on each of opposite side edges of the first panel proximate to a bottom edge of the second panel;
a second pair of tracks that are generally vertical on opposite sides of the space to be divided and generally parallel to the first set of tracks, each comprising:
a top at a point overhead,
a junction where a spur track separates from the second track,
a spur track at a point part-way to the floor that angles over from the second pair of tracks to a point below and in vertical alignment the first pair of tracks,
a bottom at a point at or above the floor,
wherein the lower second track follower interacts with the toggle switch, as the second panel is lowered, to move the toggle switch from a first position to a second position, and wherein the lower second track follower interact with the toggle switch, as the second panel is raised, to move the toggle switch from the second position to the first position;
wherein the toggle switch, when in the second position, diverts the upper second track follower from the second pair of tracks into the spur;
wherein the bottom of the second track is in vertical alignment with the first track;
wherein, as the second panel is lowered, the lower second track followers reach the bottom of the second pair of tracks and the upper second track followers reach the bottom of the spur, thus allowing the second panel, when lowered, to form a second portion of the wall; and
a toggle switch at the junction of the second track having a first position such that a track follower in the second track will continue past the junction remaining in the second track and will move the toggle to a second position such that a track follower in the second track will be diverted into the spur track;
wherein the first top point and second top point are located above a ceiling of the space allowing the first panel and second panel to be raised and stored in an overhead position above the ceiling of the space;
wherein the first and second panel can be stored in an overhead position.

2. The system of claim 1, wherein the second pair of tracks is J-shaped.

3. The system of claim 1, wherein the second pair of tracks is hockey stick shaped.

4. The system of claim 1, wherein the second pair of tracks comprises two channels disposed on opposite sides of the second panel wherein the channel comprise a vertical portion and an angled portion at the bottom of the tracks.

5. The system of claim 1, wherein the toggling cam switch comprises a first cam arm and a second cam arm attached at a pivot point.

6. The system of claim 1, wherein the first pair of tracks comprises two vertical channels disposed on opposite sides of the first panel.

7. The system of claim 1, wherein a bottom edge of the first panel and a top edge of the second panel are in touch when in a fully deployed state.

8. The system of claim 1, further comprising:
at least one first line attached to a top edge of the first panel and configured to raise and lower the first panel; and
at least one second line attached to a top edge of the second panel and configured to raise and lower the second panel.

9. The system of claim 8, further comprising:
a first lifting device connected to the first and second line for raising and lowering the first panel; and
a second lifting device connected to the third line and fourth line for raising and lowering the second panel.

10. The system of claim 9, wherein the first lifting device comprises a motor and a spool to which the first line is attached, and the second lifting device comprises a motor and a spool to which the second line is attached.

11. The system of claim 1, wherein the first pair of tracks and the second pair of tracks comprises a rack of teeth and wherein the first track followers, upper second track followers, and lower second track followers comprise driven pinion gears, configured to walk along the track of the respective tracks, to thereby raise and lower the first and second panels.

12. The system of claim 1, wherein the top portion of the second panel and the bottom portion of the first panel touch along an edge when the panels are lowered into a fully deployed position.

13. The system of claim 1, wherein the space has a ceiling and wherein the overhead position is above the ceiling.

14. The system of claim 1, wherein the first panel and the second panel are composed of materials selected from the group consisting of glass, composites, plastics, mirrors, metal, and combinations thereof.

15. The system of claim 1, wherein the first panel returns into the overhead space or does not lower, leaving the second panel as a partial divider.

16. The system of claim 1, further comprising:
a third panel comprising:
upper third track followers on sides of the third panel near a top edge of the third panel, and
lower third track followers on sides of the third panel near a bottom edge of the third panel;
a third pair of tracks that are generally vertical on opposite sides of the space to be divided and generally parallel to the second set of tracks, each comprising:
a top at a point overhead,
a junction where a spur track separates from the third track
a midpoint in the spur track at a point part-way to the floor just below the lower point of the first pair of tracks, and
a bottom at a point at or above the floor,
wherein the midpoint and bottom of the third track is in vertical alignment with the second track; and
a toggle in the at the junction of the third track having a first position such that a track follower in the third track will continue past the junction remaining in the third track and will move the toggle to a second position such that a track follower in the second track will be diverted into the spur track.

17. The system of claim 16, wherein the third pair of tracks is J-shaped.

18. The system of claim 16, wherein the third pair of tracks is hockey stick shaped.

19. The system of claim 16, wherein the second pair of tracks comprises two channels disposed on opposite sides of the second panel wherein the channel comprise a vertical portion and an angled portion at the bottom of the tracks.

20. The system of claim 16, wherein a bottom edge of the second panel and a top edge of the third panel are in touch when in a fully deployed state.
